(19) United States
(12) Patent Application Publication
(10) Pub. No.: US 2008/0028943 A1
(43) Pub. Date: Feb. 7, 2008

(54) VENDING MACHINE FOR FRUIT JUICE AND CONTROLLING METHOD THEREOF

(76) Inventor: Chang Seok Lee, Pusan (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/766,252

(22) Filed: Jun. 21, 2007

(30) Foreign Application Priority Data
Jul. 19, 2006 (KR) 1020060067401

(51) Int. Cl. A47J 31/00

(52) U.S. Cl. 99/282; 700/232

(57) ABSTRACT

An automatic vending machine for fruit juice and a control method thereof. The vending machine includes a main body having both a fruit storage unit for storing fresh fruit in a refrigerated state and a fruit feeding unit for feeding stored fresh fruit in the main body; a rotary arm unit having two rotary arms that rotate in opposite directions such that the fresh fruit, fed by the fruit feeding unit, is seated and held by the two rotary arms; a fruit cutting unit installed below the rotary arm unit and having a blade for cutting the fruit, held by the two rotary arms, into two pieces when the fruit is moved downwards; a fruit crushing unit installed below the fruit cutting unit and having two crushing bars, which are placed vertically and crush the fruit pieces held by the two rotary arms to make fruit juice when the two rotary arms holding the respective fruit pieces are rotated downwards and move downwards; and a control unit for recognizing an input bill or an input coin and controlling the vending machine in accordance with manipulation of a user.

### BACKGROUND OF THE INVENTION

1. Field of the Invention

The present invention relates, in general, to vending machines for fruit juice and, more particularly, to an automatic vending machine for selling fruit juice and a control method thereof, which can be used to quickly produce fruit juice at a selling place prior to providing the juice to a consumer and, further, can show a fruit crushing process for producing juice to the consumer, thus encouraging the consumer to trust the vending machine, and transmits information about the kinds and amounts of sold fruit juice and the operational state of the vending machine to a manager, located at a place distant from the machine, thus allowing the manager to efficiently manage the machine at low cost.

2. Description of the Related Art

Generally, a variety of automatic vending machines, which are operated in response to the input of bills or coins and sell beverages, candies, snacks, such as potato chips or popcorn, packed food, such as sandwiches, or other small articles, are well known to those skilled in the art.

Such automatic vending machines are installed in a variety of places, such as lobbies, music halls, hotels, schools or cinema houses, and allow consumers to easily, quickly and conveniently take desired food or other articles without limit as to time or place. However, the use of the conventional automatic vending machines is limited to selling canned, bottled or packed beverages or juice or to selling easily prepared beverages, such as coffee or tea, in cups.

In other words, the vending machines are typically installed in a limited range of places, and sell food or other small articles without being directly controlled by managers, so that the vending machines must have simple constructions and must be self-operated. Thus, in the related art, vending machines, configured to quickly produce fruit juice at selling places and to provide the juice to consumers, have not been proposed or used.

In recent years, entering upon the age of health consciousness, many people fear the evil influence and ill effect of preservatives or pigments, included in processed food, upon human health, so that people prefer natural food over artificial food or processed food. Thus, most people prefer home-made fruit juice, prepared by directly crushing or grinding fresh fruit into fruit juice at home, over canned, bottled or packed fruit juice, prepared by crushing or grinding fruit into juice and adding preservatives and/or pigments to the juice in factories prior to marketing it.

Thus, an automatic vending machine for selling fruit juice having a quality almost equal to that of home-made fresh fruit juice is wanted. However, the process of producing fruit juice through crushing or grinding fresh fruit is complicated, and most consumers do trust the freshness of the fruit used for producing fruit juice, and feel uneasy about the state of hygiene in which the process of producing fruit juice is executed, so that an automatic vending machine for selling fruit juice has not been developed for actual business use.

### SUMMARY OF THE INVENTION

Accordingly, the present invention has been made keeping in mind the above problems occurring in the related art, and an object of the present invention is to provide an automatic vending machine for fruit juice and a control method thereof, which can quickly produce fruit juice, having a quality almost equal to that of home-made juice, at a selling place prior to providing the juice to a consumer without limit as to time or place.

Another object of the present invention is to provide an automatic vending machine for fruit juice and a control method thereof, which show the fruit used for producing juice and the fruit crushing process for producing the juice to a consumer, thus encouraging the consumer to trust the vending machine.

A further object of the present invention is to provide an automatic vending machine for fruit juice and a control method thereof, which can maintain the interior of the vending machine cool, thus storing fresh fruit in a refrigerated state and maintaining the freshness of the fruit for a desired period of time, and is provided with a washing unit to clean the fruit crushing unit periodically, thus encouraging consumers to trust the vending machine and buy fruit juice without fear.

Still another object of the present invention is to provide an automatic vending machine for fruit juice and a control method thereof, which is provided with a data transmitting unit for transmitting information about the kinds and amounts of sold fruit juice and the operational state of the vending machine to a manager, located at a place distant from the machine, thus allowing the manager to efficiently manage the machine at low cost.

In order to achieve the above objects, according to one aspect of the present invention, there is provided an automatic vending machine for fruit juice, comprising: a main body standing upright on a support surface and provided therein with a fruit storage unit for storing fresh fruit in a refrigerated state and a fruit feeding unit for feeding stored fresh fruit in the main body; a rotary arm unit installed at a predetermined location inside the main body and comprising two rotary arms, which are rotated in opposite directions such that the fresh fruit, fed by the fruit feeding unit, is seated and held by the rotary arms; a fruit cutting unit installed below the rotary arm unit and provided with a blade for cutting each fruit, held by the two rotary arms, into two pieces when the fruit is moved downwards; a fruit crushing unit installed below the fruit cutting unit and provided with two crushing bars, which are placed vertically and crush the fruit pieces held by the two rotary arms to make fruit juice when the two rotary arms holding the respective fruit pieces are rotated downwards and move downwards; a filtering unit installed below the fruit crushing unit and provided with a filtering net for removing a solid fraction from the fruit juice; a peel discharge tray provided on a sidewall of the fruit crushing unit and discharging peels of the fruit, crushed by the crushing unit and remaining on fruit holders of the two rotary arms; a fruit juice discharge unit installed below the filtering unit and provided with a juice discharge hopper for guiding the fruit juice from the filtering net to a cup placed below the hopper; and a control unit provided on the main body at a predetermined location and recognizing an input bill or an input coin and controlling the vending machine in accordance with the manipulation of a user.

In the vending machine of the present invention, the front wall of the main body may be transparent, thus allowing the user to see the interior of the main body.

Further, the front wall of the main body may be provided with a selection button unit having a variety of buttons, bill/coin slots, and a display unit for displaying the value of input bill/coin and displaying the operational state of the vending machine.

To separately store different kinds of fresh fruit in the fruit storage unit of the main body, a partition wall may be provided in the fruit storage unit, thus dividing the fruit storage unit into a first storage part and a second storage part. Each of the first storage part and the second storage part may be provided with a fruit feeding means for feeding stored fresh fruit, thus allowing a consumer to select a first kind of fresh fruit, a second kind of fresh fruit, or a mixture of the first and second kinds of fresh fruit, as desired.

In the present invention, the rotary arm unit may comprise a first drive unit for rotating the two rotary arms in opposite directions and a rotary arm base for supporting both the two rotary arms and the first drive unit and sliding upwards and downwards.

The two rotary arms may be placed at respective locations spaced apart from each other by a predetermined distance. The lower end of each of the rotary arms may be coupled to a drive shaft of the first drive unit, thus receiving rotating force from the drive shaft. The upper end of each of the rotary arms may be provided with a bowl-shaped fruit holder, which seats fresh fruit therein. The fruit holder may be provided with a gripper for holding and discharging the fresh fruit. The operation of the gripper may be controlled by the control unit.

The rotary arm unit of the present invention may further comprise a second drive unit for moving the rotary arm base, to which the two rotary arms are securely mounted, upwards and downwards. The second drive unit may comprise a gear assembly comprising a rack and a pinion or a plurality of cylinder actuators.

The fruit cutting unit may comprise a blade, which passes between the rotary arms and cuts fresh fruit into two pieces, and a blade holder for holding the blade.

The fruit crushing unit may comprise two crushing bars, which are placed in vertical directions and correspond to the ends of the two rotary arms rotated downwards, and a crushing bar holder for holding the crushing bars.

Further, the filtering unit may comprise a filtering net, having a net structure, placed below the fruit crushing unit, and a filtering net holder for holding the filtering net.

Further, the fruit juice discharge unit may be provided with a juice discharge hopper having a hopper-shaped discharge hole in the center thereof.

The control unit detects fresh fruit fed by the fruit feeding unit and controls the rotary arm unit such that the fresh fruit, fed by the fruit feeding unit, is held and cut into two pieces. Described in detail, the control unit controls the gripper such that the gripper holds the fresh fruit in the fruit holder, and controls the first drive unit such that the first and second rotary arms are rotated inwards until they face each other, thus holding the fresh fruit. Thereafter, the control unit controls the second drive unit such that the rotary arm base, to which the first and second rotary arms are securely mounted, is moved downwards, thus cutting the fresh fruit, held by the first and second rotary arms, using the blade placed below the rotary arm base.

Thereafter, the control unit controls the vending machine such that the two cut pieces of fresh fruit are crushed into fresh fruit juice. Described in detail, the control unit controls the first drive unit such that the first and second rotary arms are rotated downwards until the rotary arms are placed in vertical directions, and controls the second drive unit such that the rotary arm base is moved downwards, so that the two cut pieces of fresh fruit, held in the respective ends of the first and second rotary arms, are crushed by the crushing bars, vertically placed below the rotary arm base, thus making fresh fruit juice.

Further, the control unit controls the vending machine such that the peels of the crushed fresh fruit are discharged and the first and second rotary arms are returned to their original locations. Described in detail, the control unit controls the second drive unit such that the rotary arm unit is moved upwards, and controls the first drive unit such that the ends of the first and second rotary arms face the peel discharge tray and, in the above state, releases the gripper, this discharging the peels of the crushed fruit to the peel discharge tray. Thereafter, the control unit controls the first drive unit such that the first and second rotary arms are rotated upwards until they are placed vertically, and controls the second drive unit such that the first and second rotary arms are moved upwards to their original locations, thus restoring the initial state of the vending machine.

In the present invention, the control unit may be provided with a data transmitting unit, which is electrically connected to a remote data transmission module and transmits data about the operational state of the vending machine to a manager, located at a place distant from the machine, thus allowing the manager to remotely monitor the operational state of the vending machine and remotely control the vending machine. The remote data transmission module may use one of conventional RF (Radio Frequency) transmission, Zigbee transmission or Bluetooth transmission.

The method of controlling the automatic vending machine for selling fruit juice according to the present invention comprises: determining the value of an input bill or coin, the kind and amount of selected fresh fruit and the presence of a cup; producing fruit juice in accordance with the selection of a consumer when fruit exists in the vending machine, and providing the juice to the consumer; and transmitting data about the kind and amount of sold fresh fruit and the operational state of the vending machine to a terminal of a manager and transmitting a control signal, received from the terminal of the manager, to the control unit, thus operating the vending machine in response to the control signal.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating the construction of an automatic vending machine for fruit juice according to the present invention;

FIG. 2 is a view illustrating the construction of a fruit crushing unit according to the present invention;

FIG. 3 is a block diagram illustrating the construction of a control unit of the automatic vending machine for fruit juice according to the present invention;

FIG. 4A through FIG. 4E are views illustrating the operation of the fruit crushing unit according to the present invention;

FIG. 5 is a flowchart of a control method for controlling the automatic vending machine according to the present invention;

FIG. 6 is a detailed flowchart of the control method for controlling the automatic vending machine according to the present invention; and

FIG. 7 is a flowchart of a process for producing fruit juice according to the present invention.

### DETAILED DESCRIPTION OF THE INVENTION

Reference will now be made in greater detail to an automatic vending machine for fruit juice and a control method thereof according to a preferred embodiment of the invention, an example of which is illustrated in the accompanying drawings. Wherever possible, the same reference numerals will be used throughout the drawings and the description to refer to the same or like parts.

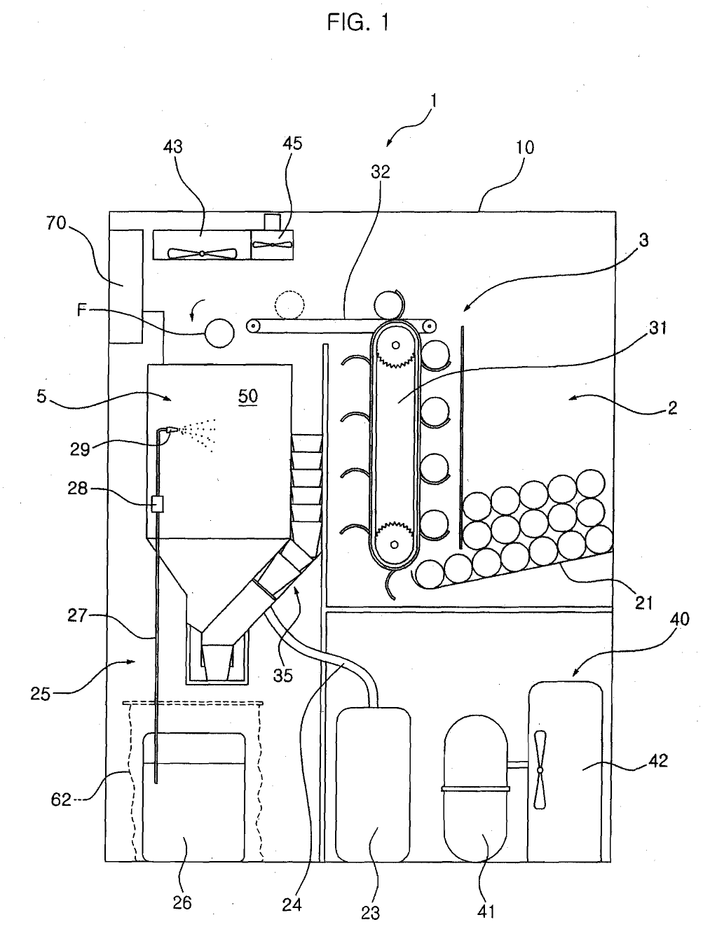

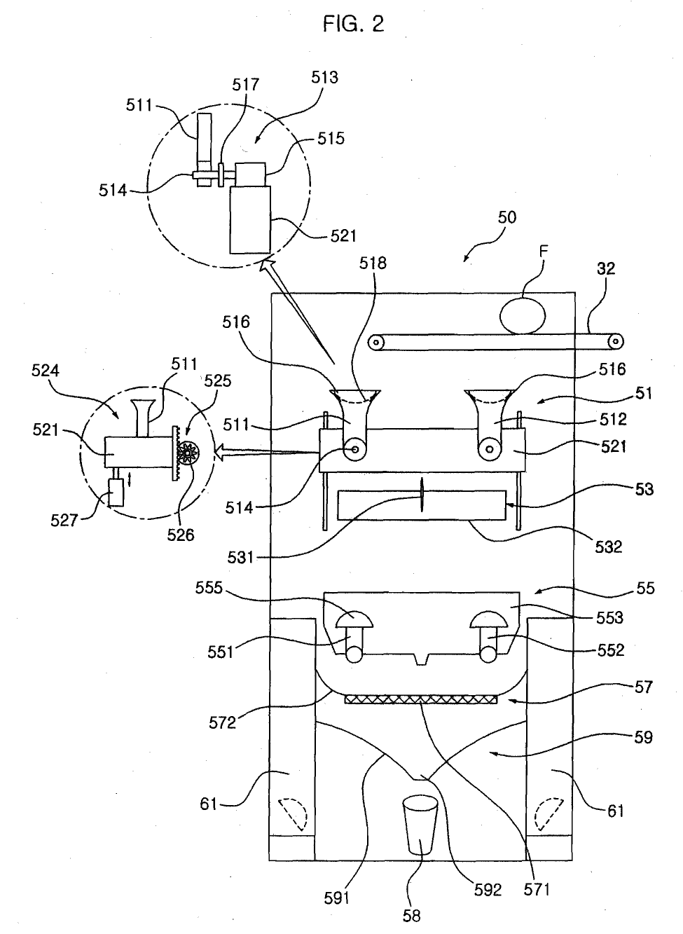

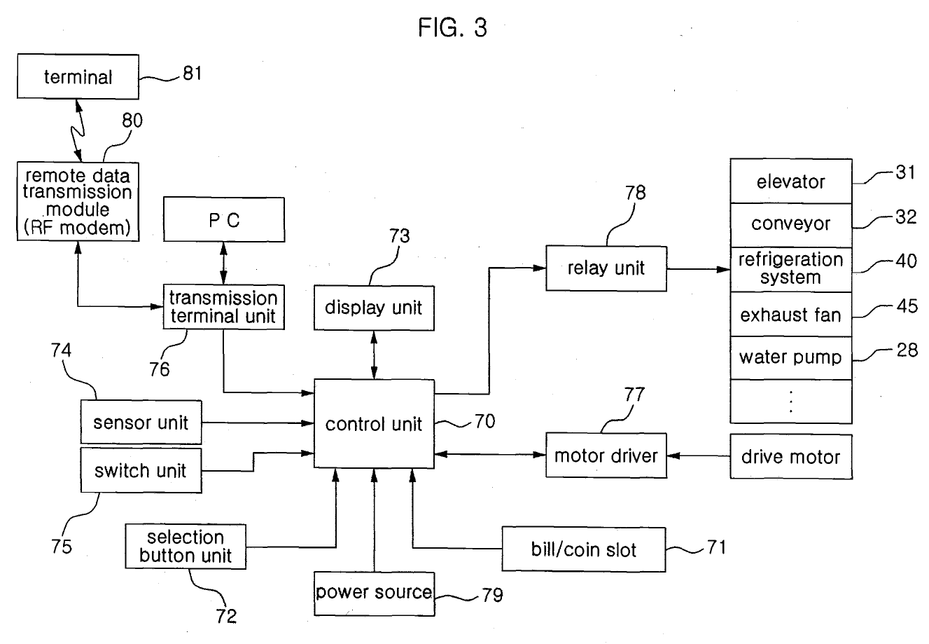

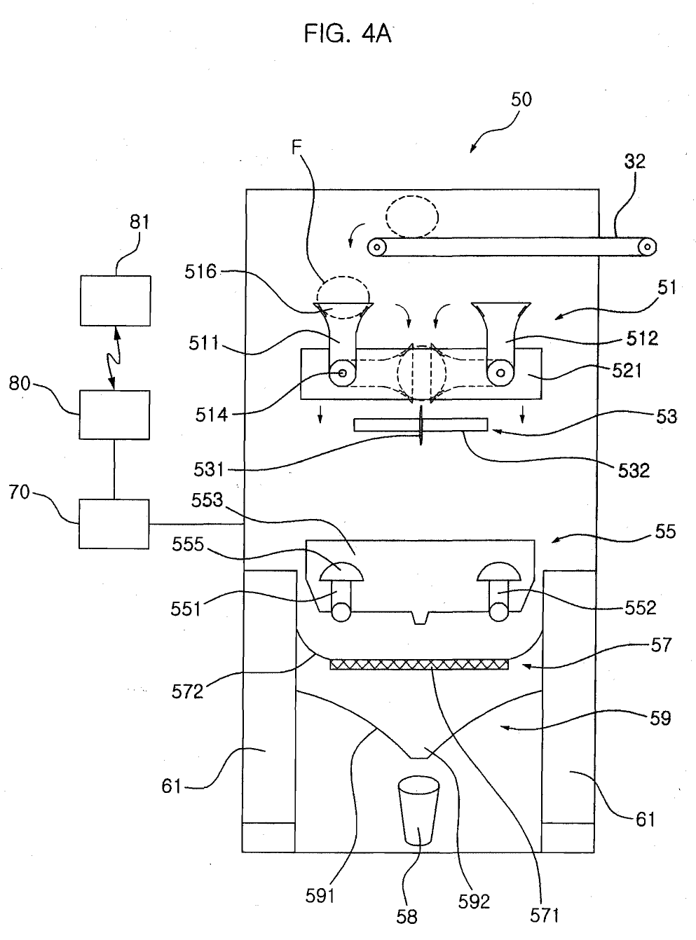

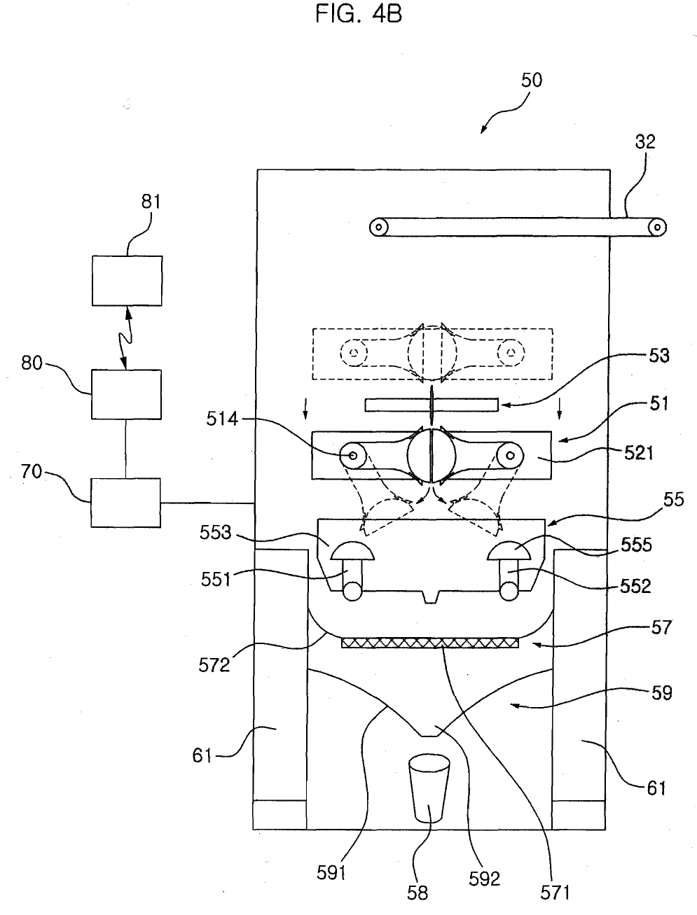

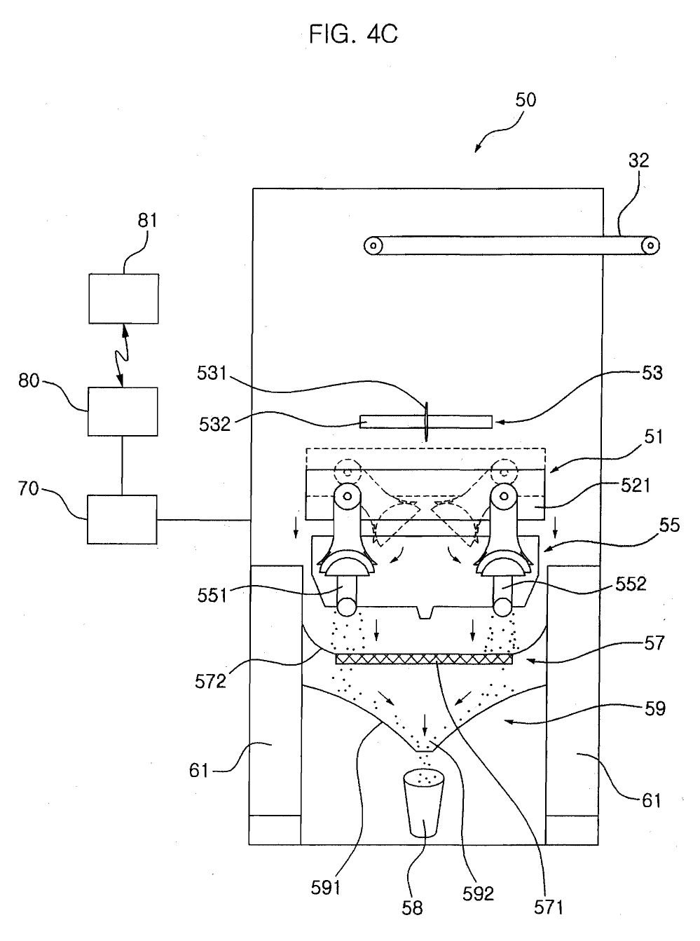

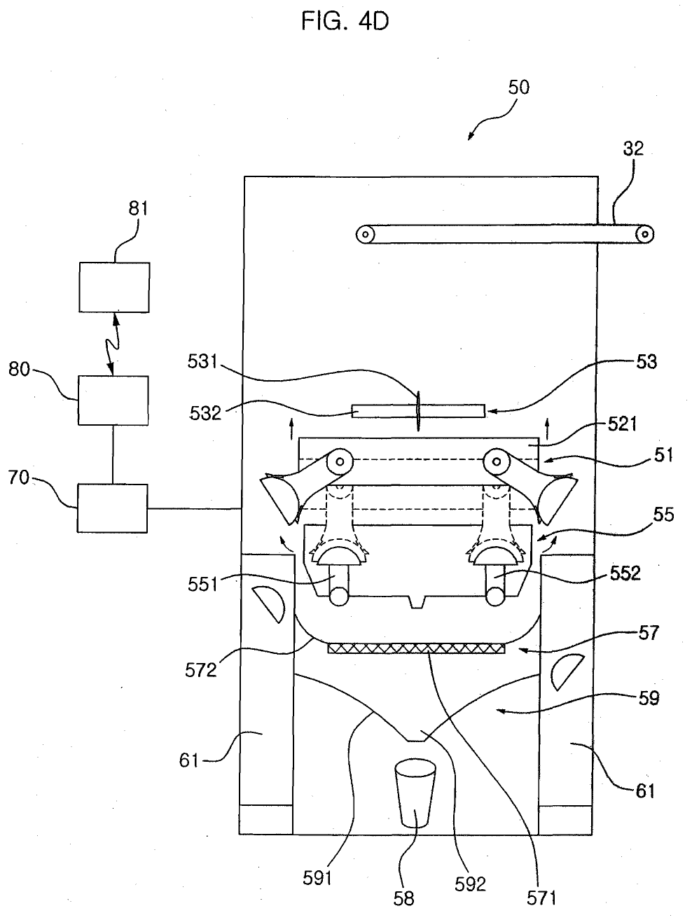

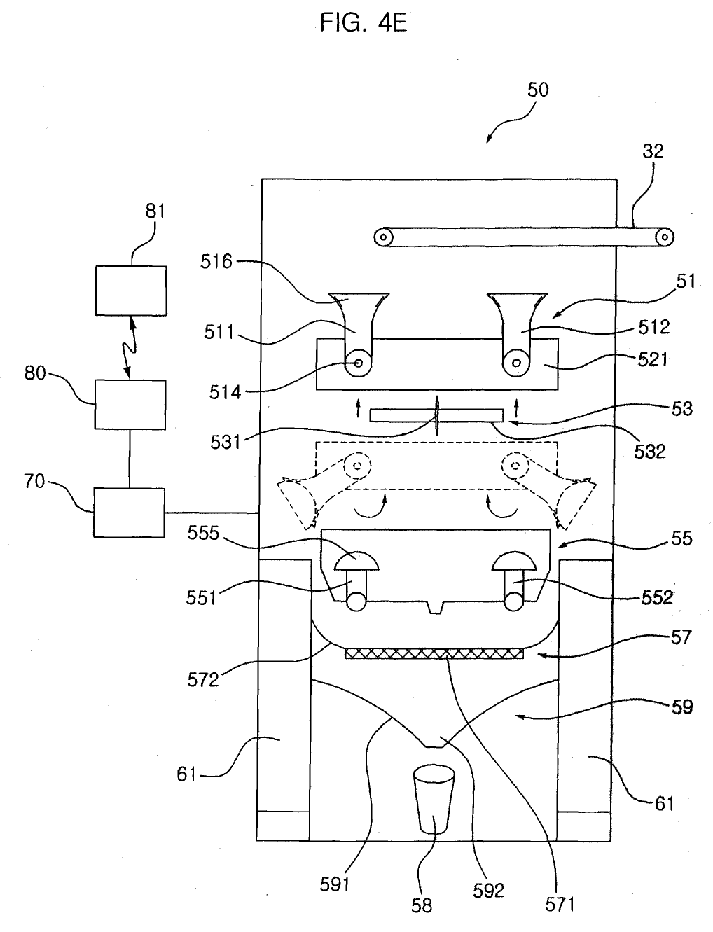

FIG. 1 is a view illustrating the construction of an automatic vending machine for fruit juice according to the present invention. FIG. 2 is a view illustrating the construction of a fruit crushing unit according to the present invention. FIG. 3 is a block diagram illustrating the construction of a control unit of the automatic vending machine for fruit juice according to the present invention. FIG. 4A through FIG. 4E are views illustrating the operation of the fruit crushing unit according to the present invention.

As shown in the drawings, the automatic vending machine 1 for fruit juice according to the present invention comprises a main body 10, which stands upright on a support surface. Provided in the main body 10 are a fruit storage unit 2 for storing fresh fruit in a refrigerated state, a fruit feeding unit 3 for feeding the stored fruit in the main body 10, and a fruit crushing unit 5 for cutting and crushing the fresh fruit while holding the fruit, thus producing fruit juice. The fruit crushing unit 5 is provided with a fruit crusher 50.

In the vending machine 1, a predetermined part of the main body 10 is configured as a transparent part such that a consumer can see the fruit crushing process, which is the fruit juice producing process. For example, the front wall of the crushing unit 5 is made of a transparent panel. In the same manner as a conventional automatic vending machine, the main body 10 is configured as a rectangular cross-sectional shape or some other irregular shape.

The fruit storage unit 2 has a construction capable of sequentially discharging fresh fruit, which is heaped in the unit 2. The construction of the fruit storage unit 2, which can sequentially discharge stored fresh fruit, is similar to that of a conventional automatic vending machine, and further explanation is deemed unnecessary.

Further, the fruit storage unit 2 is provided therein with a partition wall for dividing the storage unit 2 into a first storage part and a second storage part, which can separately store different kinds of fresh fruit in respective storage parts. Further, each of the first storage part and the second storage part of the fruit storage unit 2 is provided with a feeding means for feeding the stored fresh fruit, so that a consumer can select fruit juice of a first kind of fresh fruit stored in the first storage part, fruit juice of a second kind of fresh fruit stored in the second storage part, or mixed fruit juice of the first and second kinds of fresh fruit, as desired.

As described above, the fruit storage unit 2 can store different kinds of fruit in the respective storage parts, and it should be understood that the construction of the fruit storage unit 2 of the present invention is not limited to the construction shown in the drawings.

The fruit feeding unit 3 comprises an elevator 31 for feeding stored fresh fruit upwards in a vertical direction, and a conveyor 32 for feeding the elevated fresh fruit to the crushing unit 5 in a horizontal direction. The conveyor 32 is placed such that the fed fresh fruit F is dropped on the fruit holder of a rotary arm, which will be described later herein. In the present invention, the fruit feeding unit preferably comprises the vertical elevator 31 and the horizontal conveyor 32. However, it should be understood that the construction of the fruit feeding unit is not limited to the construction shown in the accompanying drawings of the present invention.

Further, a refrigeration system 40, which comprises a compressor 41 and a condenser 42, is installed at a lower location in the main body 10. Further, provided in the upper part of the main body 10 are an evaporator 43, which provides cool air, and an exhaust fan 45, which discharges air to the outside of the main body 42. This is because the interior of the main body 10 must be maintained at a low temperature state capable of preserving fresh fruit for a lengthy period of time.

The main body 10 is provided with a washing unit 25 for washing the fruit crusher 50 periodically. The washing unit 25 comprises a water storage tank 26 for storing wash water, a water inlet pipe 27 for introducing the wash water into the fruit crusher 50, a water pump 28 provided on the water inlet pipe 27, a spray nozzle 29 for spraying the pumped wash water, a drain pipe 24 for draining used wash water, and a drain tank 23 for collecting the drained wash water.

Further, the main body 10 is provided with a cup supply unit 35 for supplying cups. The cup supply unit 35 has the same construction as that of a cup supply unit provided in a conventional coffee vending machine. The cup supply unit 35 is well known to those skilled in the art, and thus further explanation is deemed unnecessary. Further, in the vending machine of the present invention, the cup supply unit may be altered to use glass cups in place of paper cups, or may be removed from the machine.

Hereinbelow, the fruit crusher 50 according to the present invention will be described with reference to FIG. 2. As shown in FIG. 2, the fruit crusher 50 is provided in the fruit crushing unit 5 of the main body 10. The fruit crusher 50 comprises a rotary arm unit 51, a fruit cutting unit 53, a fruit crushing part 55, a filtering unit 57, and a juice discharge unit 59.

First, the rotary arm unit 51 comprises two rotary arms 511 and 512, which hold fresh fruit fed by the fruit feeding unit 3 and are rotated such that the fresh fruit can be cut into two pieces and squeezed into fruit juice, and a rotary arm base 521 for supporting the two rotary arms 511 and 512. The rotary arm base 521 is movably installed in the main body 10 such that the rotary arm base 521 is moved upwards and downwards.

The fruit cutting unit 53, which is installed below the rotary arm unit 51, comprises a blade 531 for cutting the fresh fruit, held by the two rotary arms 511 and 512, into two pieces, and a blade holder 532 for holding the blade 531. The blade holder 532 is securely mounted in the main body 10.

The fruit crushing part 55, which is placed below the fruit cutting unit 53, comprises two crushing bars 551 and 552 and a crushing bar holder 552 for holding the crushing bars 551 and 552. The two crushing bars 551 and 552 are placed such that, when the rotary arms 511 and 512 are moved downwards after the arms 511 and 512 are rotated downwards and are oriented vertically, the two crushing bars 551 and 552 are aligned with the ends of the two rotary arms 511 and 512, respectively.

The filtering unit 57, which is placed below the fruit crushing part 55, comprises a filtering net 571 having a predetermined mesh and a filtering net holder 572 for holding the filtering net 571 in the main body 10.

Further, the juice discharge unit 59, which is placed below the filtering unit 57, comprises a juice discharge hopper 591, which is securely mounted in the main body 10 and has a hopper-shaped discharge hole 592 for guiding fruit juice, passing through the filtering net 571, to a cup 58 placed below the discharge hole 592.

Further, two peel discharge trays 61 are placed below opposite sides of the fruit crushing part 55, respectively, and collect the peels of the fresh fruit crushed by the fruit crushing part 55. The peels collected by the two peel discharge trays 61 are discarded into the garbage bag 62 shown in FIG. 1.

Referring to FIG. 3, the control unit 70, which is installed on a sidewall of the main body 10, is provided with software for controlling the operation of the vending machine. The control unit 70 comprises a bill/coin slot 71 for receiving a bill or a coin, counting the value of the input bill/coin, and displaying the value of the input bill/coin; a selection button unit 72 provided with a variety of selection buttons; a display unit 73 for displaying the operational state of the vending machine; a sensor unit 74 for receiving data from a variety of sensors for sensing the presence of fresh fruit and a cup, the water temperature, the water level, etc.; a switch unit 75 for controlling the locked state of a door, the on/off state of a light, and the on/off state of a safety switch, and executing a self diagnosis function in a board; a transmission terminal unit 76 for exchanging a variety of data with a terminal 81 of the manager, and connected to an external personal computer (PC), thus executing the self diagnosis function; a motor driver 77 for driving a drive motor of the drive unit; a relay unit 78 for controlling the operation of a variety of electric devices, such as an elevator 31, a horizontal conveyor 32, a refrigeration system 40, an exhaust fan 45, and a water pump 28, and electrically connected to a power source 79, which supplies electricity to the electric devices. In the above state, the selection button unit 72 includes a start button, a fruit selection button, a cancel button for requiring return of the input bill/coin, etc.

Further, the transmission terminal unit 76 of the control unit 70 is provided with a remote data transmission module 80 for exchanging data with the terminal 81 of the manager using a wired system or a wireless system. Thus, the automatic vending machine 1 for fruit juice according to the present invention can be remotely monitored and remotely controlled. The remote data transmission module 80 may execute wired transmission, or wireless transmission using one of RF (Radio Frequency) transmission, Zigbee transmission or Bluetooth transmission.

With reference to FIG. 2, the first rotary arm 511 and the second rotary arm 512 of the rotary arm unit 51 according to the present invention are placed at opposite locations, which are oppositely spaced apart from the crushing unit 5 by a predetermined interval. In other words, the first and second rotary arms 511 and 512 are placed such that they are rotatable inwards, and when they are rotated inwards at 90° angles, fresh fruit can be held by the ends of the facing first and second rotary arms 511 and 512.

Further, the lower ends of the first and second rotary arms 511 and 512 are coupled to respective drive shafts 514 of a first drive unit 513 and receive rotating force from the drive shafts 514. The upper ends of the first and second rotary arms 511 and 512 are concave to form respective fruit holders 516 for holding fresh fruit having a variety of sizes. Each of the fruit holders 516 is provided with a gripper 518 for holding and discharging fresh fruit seated in the fruit holders 516. The operation of the grippers 518 is controlled by the control unit 70.

The first drive unit 513, which is shown in FIG. 2, rotates the first and second rotary arms 511 and 512. Preferably, the first drive unit 513 comprises a first drive motor 515, which generates rotating force, and a power transmission unit 517, which has a belt transmission structure, a chain transmission structure, or some other structure capable of executing a power transmission function. The power transmission unit 517 connects the first drive motor 515 to the drive shafts 514 of the first and second rotary arms 511 and 512 and transmits the rotating force of the first drive motor 515 to the drive shafts 514, and rotates the two rotary arms 511 and 512 in opposite directions. The construction of the power transmission unit 517 is well known to those skilled in the art, and further explanation is thus deemed unnecessary.

The second drive unit 524, which is shown in FIG. 2, moves the rotary arm base 521, which is movably placed on the inner surface of the main body 10, upwards and downwards. The second drive unit 524 may comprise a gear assembly 525, which comprises a rack and a pinion capable of converting the rotating motion of the second drive motor 526 into upward and downward rectilinear motion. Alternatively, the second drive unit 524 may comprise a plurality of cylinder actuators 527 for moving the rotary arm base 521 upwards and downwards. As a further alternative, the second drive unit 524 may comprise the combination of a screw shaft and a drive motor. In other words, the second drive unit 524 according to the present invention may be configured as a structure capable of moving the rotary arm base 521 upwards and downwards.

The lower ends of the first and second crushing bars 551 and 552 of the fruit crushing part 55 are vertically and securely mounted to a crushing unit holder 553, which is securely mounted to the main body 10. Each of the upper ends of the first and second crushing bars 551 and 552 is provided with a semicircular protrusion 555 capable of efficiently crushing fresh fruit juice, with a plurality of lugs formed on the upper surface of the protrusion 555 in a spiral arrangement.

The filtering net 571 has a net structure having a predetermined mesh capable of removing a solid fraction from fruit juice, produced by the crushing bars 551 and 552, and may be provided with a mesh control unit (not shown) for controlling the mesh of the net. For example, the filtering net 571 may comprise a plurality of parallel wires, which are arranged such that the intervals between the wires can be adjusted as desired. During a process of removing a solid fraction from fruit juice, the intervals between the parallel wires of the filtering net 571 are reduced. However, during a process of washing the filtering net 571, the intervals between the parallel wires of the filtering net 571 are increased to allow the solid fraction to easily pass between the wires of the filtering net 571.

Hereinbelow, the operation of the automatic vending machine for fruit juice according to the present invention will be described with reference to FIG. 4A through FIG. 4E.

As shown in FIG. 4A, the control unit 70 directs the conveyor 32 to feed fresh fruit, selected by a consumer, and operates the gripper 518 of the fruit holder 516 of the first rotary arm 511 in response to an output signal of a sensor (optical sensor, not shown), thus stably holding the fresh fruit.

Thereafter, the control unit 70 operates the first drive motor 515 of the first drive unit 513 (see FIG. 2) such that the first and second rotary arms 511 and 512 are rotated inwards at 90° angles and face each other. Thus, the fruit holder 516 of the second rotary arm 512 holds the fresh fruit F using the gripper 518 thereof.

Thereafter, as shown in FIG. 4B, the control unit 70 operates the second drive motor 526 of the second drive unit 524 (see FIG. 2), so that the gear assembly 525, comprising the rack and pinion, moves the rotary arm base 521 downwards. Therefore, the fresh fruit F, which is held between the first and second rotary arms 511 and 512, is moved downwards along with the rotary arm base 521. In the above state, the blade 531 is placed on the path of the fresh fruit F, so that the fresh fruit F is cut into two pieces.

As shown in FIG. 4C, the control unit 70 rotates the drive motor 515 of the first drive unit 513 (see FIG. 2) at 90° angles such that the first and second rotary arms 511 and 512 face downwards. In the above state, one of the two pieces of the cut fresh fruit F is held by the fruit holder 516 of the first rotary arm 511, while the remaining one is held by the fruit holder 516 of the second rotary arm 512.

Thereafter, the control unit 70 rotates the second drive motor 526 of the second drive unit 524 further, such that the rotary arm base 521 is moved further downwards. When the rotary arm base 521 is moved further downwards, the two pieces of fresh fruit F are crushed by the two crushing bars 551 and 552, which are placed vertically below the rotary arm base 521. In the present invention, the crushing bars 551 and 552 are configured to rotate around their rotating axes, which do not move, thus increasing the fruit crushing effect.

When a sufficient amount of fruit juice has been produced, as shown in FIG. 4D, the control unit 70 rotates the second drive motor 526 of the second drive unit 524, thus moving the rotary arm base 521 upwards, and, at the same time, rotates the drive motor 515 of the first drive unit 513 at an angle of about 300 outwards, thus releasing the grippers 518 and dropping the peels of the fruit, held in the fruit holders of the first and second rotary arms 511 and 512, onto the peel discharge tray 61, which is placed below the fruit holders 516.

Thereafter, as shown in FIG. 4E, the control unit 70 operates the first drive unit 513 and the second drive unit 524, thus moving the rotary arm base 521 upwards and rotating the first and second rotary arms 511 and 512 to their initial positions.

Further, as shown in FIG. 1, the control unit 70 counts the number of fresh fruit fed from the fruit storage unit 2, controls the operation of the elevator 31 and the horizontal conveyor 32 of the fruit feeding unit 3, detects the water temperature inside the main body 100, thus controlling the operation of the refrigeration system 40, and detects the state of contamination of the filtering net 571 prior to operating the water pump 28 to wash the fruit crusher 50 periodically.

Further, the control unit 70 is electrically connected both to the bill/coin slot 71 and to the selection button unit 72, thus determining the value of an input bill or coin and the kind and amount of fresh fruit selected by a consumer prior to outputting control signals. Further, the control unit 70 opens or closes the door, operates or stops the evaporator and the exhaust fan, and turns on or off the light.

Further, the main body 70 is provided with the transmission terminal unit 76, which is connected to the remote data transmission module 80 and transmits the operational state of the control unit 70 to the terminal of the manager, located at a place distant from the vending machine, and receives control signals from the terminal of the manager, thus allowing the manager to remotely monitor the operational state of the vending machine and remotely control the vending machine.

Hereinbelow, the method of controlling the automatic vending machine for fruit juice according to the present invention will be described with reference to the accompanying drawings.

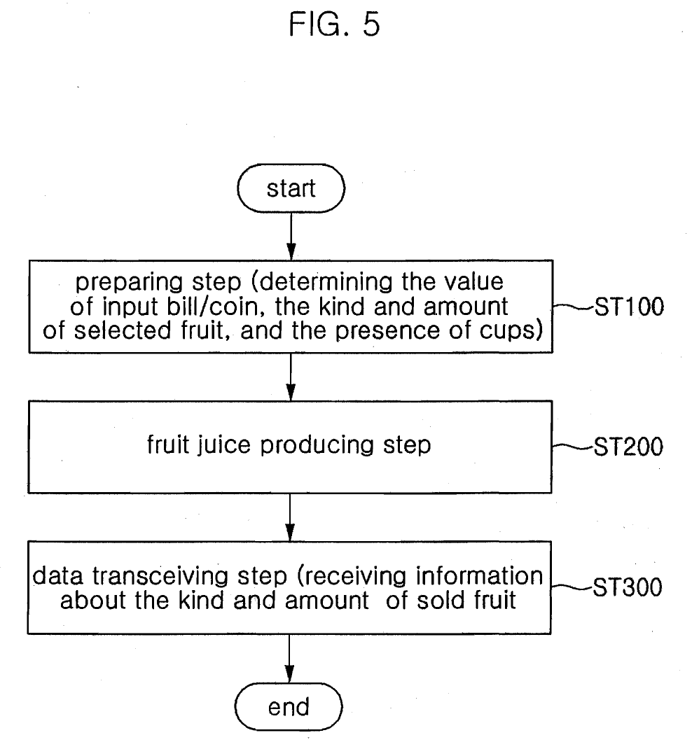

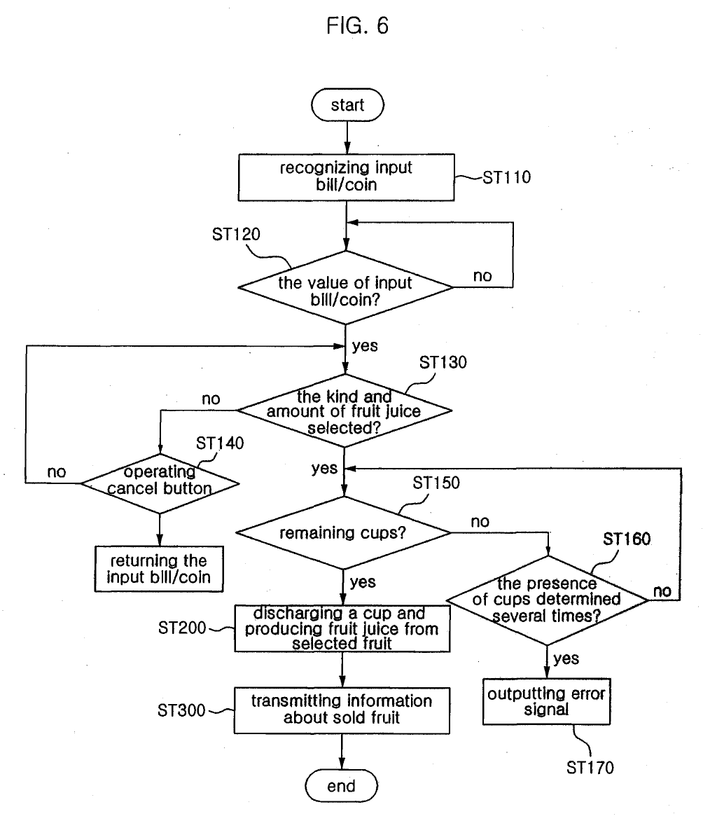

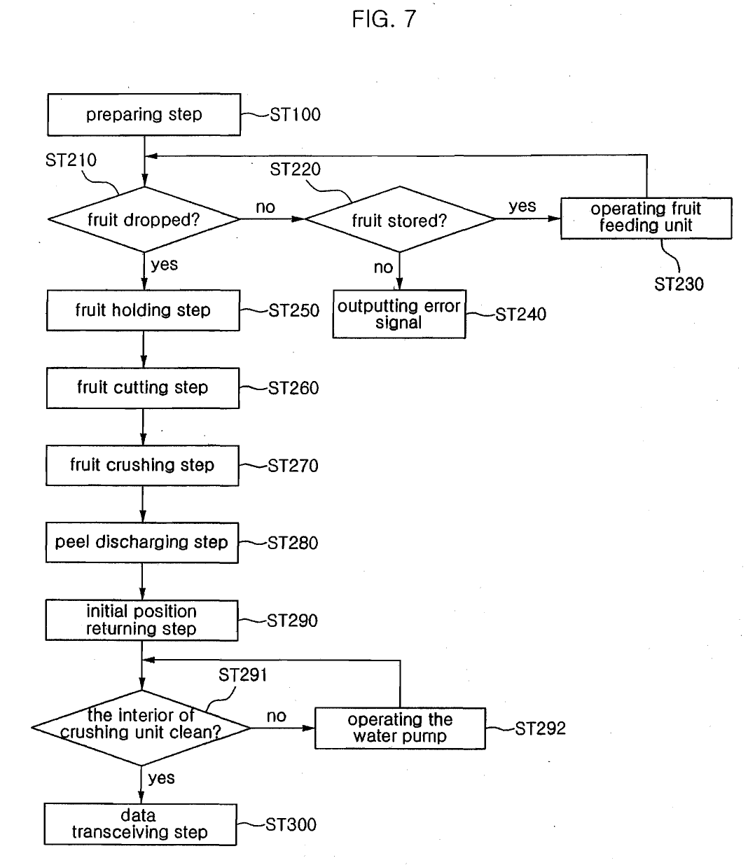

FIG. 5 is a flowchart of the method for controlling the automatic vending machine according to the present invention. FIG. 6 is a detailed flowchart of the control method for controlling the automatic vending machine according to the present invention. FIG. 7 is a flowchart of the process for producing fruit juice according to the present invention.

First, as shown in FIG. 5, the method for controlling the automatic vending machine for fruit juice according to the present invention comprises a preparing step ST100, a fruit juice producing step ST200, and a data transceiving step ST300.

At the preparing step ST100, the control unit 70 determines the value of an input bill or coin, the kind and amount of fresh fruit selected by a consumer, and the presence of a cup.

When a cup and selected fresh fruit are present in the vending machine, at the fruit juice producing step ST200, the control unit controls the machine so that the selected fruit is fed, cut into two pieces while being held by the rotary arms, and crushed into fruit juice. Thereafter, the control unit discharges the peels of the crushed fruit and returns the rotary arms to their original positions.

At the data transceiving step ST300, the control unit executes a data transmitting step for transmitting information about the kinds and amounts of sold fruit juice to the terminal of a manager, located at a place distant from the machine, and a data receiving step for receiving a control signal output from the terminal of the manager and controlling the vending machine according to the input control signal.

Hereinbelow, the method of controlling the operation of the automatic vending machine for fruit juice according to the present invention will be described in detail, with reference to the flowcharts of FIG. 6 and FIG. 7.

As shown in FIG. 6, when a consumer inputs a bill or a coin into the bill/coin slot 71 of the main body 10, a bill/coin sensor, provided in a bill/coin sensing unit of the main body 10, detects the input bill or coin at ST110, determines the state and value of the input bill or coin at ST120, and transmits a signal indicative of information about the input bill or coin to the control unit 70.

Upon receiving the signal output from the bill/coin slot 71, the control unit 70 operates the signal and controls the selection button unit 72, thus activating the selection buttons provided in the selection button unit 72. When the selection button unit 72 is activated, the consumer selects the kind and amount of favorite fruit using the selection buttons at ST130. If the consumer does not select any fruit, the cancel button is operated at ST140, and the input bill or coin is returned to the consumer.

However, when the consumer selects the kind and amount of fresh fruit, the control unit determines the presence of a cup at ST150. When cups remain in the vending machine, the control unit controls the machine to discharge a cup and executes a process of producing fruit juice from the selected fruit at ST200. However, when no cups remain in the vending machine, the control unit 70 determines the presence of a cup in the vending machine several times at ST160. When the control unit determines that there are no cups remaining in the vending machine, an error message is displayed on the display 73 and an error signal is transmitted to the selection button unit 72 at ST170.

The process of producing fruit juice will be described hereinbelow with reference to the flowchart of FIG. 7 and schematic views of FIG. 4A through FIG. 4E.

The control unit 70 receives a signal from the sensor unit 74 and determines whether fresh fruit is dropped into the fruit holder of the first rotary arm 511 at ST210. When fresh fruit has been dropped into the fruit holder of the first rotary arm 511, the control unit continues the fruit juice producing process. However, when no fresh fruit has been dropped into the fruit holder of the first rotary arm 511, the control unit determines whether fruit is present in the fruit storage unit 2 at ST220. If fruit is present in the fruit storage unit 2, the control unit operates both the elevator 31 and the conveyor 32 and feeds fruit. However, if no fruit is present in the fruit storage unit 2, the control unit determines that the vending machine is in an error state and displays an error message at ST240.

As shown in FIG. 7 and FIG. 4A, when fresh fruit is seated in the fruit holder of the first rotary arm 511, the fruit sensor detects the loaded fresh fruit F and the gripper 518 of the first rotary arm 511 is operated to hold the fresh fruit. Thereafter, the first drive unit is operated to rotate the first and second rotary arms 511 and 512 in directions shown by the arrows in FIG. 4A, thus bringing the first and second rotary arms 511 and 512 into horizontal states. In the above state, the gripper of the second rotary arm 512 is operated to stably hold the fresh fruit (ST260), thus preventing the fruit from being undesirably removed from the grippers.

Thereafter, as shown in FIG. 7 and FIG. 4B, the control unit 70 operates the second drive motor of the second drive unit and moves the first and second rotary arms 511 and 512, which hold the fresh fruit, downwards, thus cutting the fresh fruit into two pieces using the blade 531, which is placed below the rotary arm base 521, at ST260.

Thereafter, as shown in FIG. 7 and FIG. 4C, the control unit 70 controls the first drive unit, so that the facing first and second rotary arms 511 and 512 are rotated downwards at 90° angles. Thereafter, the control unit 70 controls the second drive unit and moves the first and second rotary arms 511 and 512 downwards, so that the pieces of the cut fresh fruit, held by the first and second rotary arms 511 and 512, can be crushed. In other words, when the first and second rotary arms 511 and 512 are moved downwards, the pieces of the cut fruit are crushed between the first and second rotary arms 511 and 512 and the respective crushing bars 551 and 552 to make fruit juice at ST270.

The fruit juice, produced through the fruit crushing process executed by the crushing bars 551 and 552, is filtered by the filtering net, so that a solid fraction is removed from the fruit juice. Thereafter, the fruit juice is placed in the discharged cup prior to being provided to the consumer.

Meanwhile, as shown in FIG. 7 and FIG. 4D, to discard the peels of crushed fresh fruit, held by the first and second rotary arms 511 and 512, the control unit 70 operates the second drive unit and moves the first and second rotary arms upwards and, at the same time, operates the first drive unit and rotates the first and second rotary arms 511 and 512 in the directions shown by the arrows of FIG. 4D. Thereafter, the holding force of the grippers is released to discharge the peels of the crushed fresh fruit onto the peel discharge tray 61 at ST280.

Thereafter, as shown in FIG. 7 and FIG. 4E, the control unit 70 controls the first drive unit and the second drive unit and returns the first and second rotary arms 511 and 512 to their initial positions at ST290.

When the first and second rotary arms 511 and 512 are returned to their initial positions, the control unit 70 transmits information about the kind and amount of sold fresh fruit and the operational state of the vending machine to the terminal 81 of the manager, located at a place distant from the machine, through both the transmission terminal unit 76 and the remote data transmission module 80.

Thus, the manager can remotely monitor information about the kinds and amounts of sold fresh fruit, the kinds and amounts of remaining fresh fruit, and the operational state of the vending machine, particularly operational errors of the vending machine, from the display of his/her terminal 81.

Further, the manager can transmit a control signal to the control unit of the vending machine by manipulating the input unit of the terminal 81. Upon receiving the control signal from the manager, both through the remote data transmission module 80 and through the transmission terminal unit 76, the control unit 70 controls the elements of the vending machine in accordance with the control signal, so that the manager can remotely control the operation of the vending machine.

Further, the control unit of the automatic vending machine 1 for fruit juice according to the present invention determines at ST291 whether or not the interior of the crushing unit is clean. If the interior of the crushing unit is not clean, the control unit operates the water pump at ST292 and washes the interior of the fruit crusher 50.

As is apparent from the above description, the automatic vending machine for fruit juice and the control method thereof according to the present invention provides advantages in that the vending machine can show the fruit crushing process for producing juice to a consumer, thus encouraging the consumer to trust the vending machine, and allows the consumer to freely select fruit juice of a first kind of fresh fruit, fruit juice of a second kind of fresh fruit, or mixed fruit juice of the first and second kinds of fresh fruit, as desired. The vending machine quickly produces fresh fruit juice, having a quality almost equal to that of home-made juice, at a selling place prior to providing the juice to a consumer without limit as to time or place. Thus, the vending machine meets the requirement of consumers in the age of health consciousness.

Further, the vending machine of the present invention is provided with a refrigeration system and washing unit, thus providing fresh and healthful fruit juice, and can be remotely monitored and remotely controlled, so that a manager can easily manage a plurality of automatic vending machines at low cost.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An automatic vending machine for fruit juice, comprising:
a main body, standing upright on a support surface and provided therein with a fruit storage unit for storing fresh fruit in a refrigerated state and a fruit feeding unit for feeding stored fresh fruit in the main body;
a rotary arm unit installed at a predetermined location inside the main body and comprising two rotary arms that rotate in opposite directions such that the fresh fruit, fed by the fruit feeding unit, is seated and held by the rotary arms;
a fruit cutting unit installed below the rotary arm unit and provided with a blade for cutting the fruit, held by the two rotary arms, into two pieces when the fruit is moved downwards;
a fruit crushing unit installed below the fruit cutting unit and provided with two crushing bars, which are placed vertically and crush the fruit pieces held by the two rotary arms to make fruit juice when the two rotary arms holding the respective fruit pieces are rotated downwards and move downwards; and
a control unit provided on the main body at a predetermined location and recognizing an input bill or an input coin and controlling the vending machine in accordance with manipulation of a user.

2. The automatic vending machine for fruit juice according to claim 1, wherein the main body comprises a transparent part for allowing a user to see an interior of the main body.

3. The automatic vending machine for fruit juice according to claim 1, further comprising:
a filtering unit installed below the fruit crushing unit and provided with a filtering net for removing a solid fraction from the fruit juice;
a peel discharge tray provided on a sidewall of the fruit crushing unit and discharging peels of the fruit, crushed by the crushing unit and remaining on fruit holders of the two rotary arms; and
a fruit juice discharge unit installed below the filtering unit and provided with a juice discharge hopper for guiding the fruit juice from the filtering net to a cup placed below the hopper.

4. The automatic vending machine for fruit juice according to claim 1, wherein the rotary arm unit comprises the two rotary arms placed at respective locations spaced apart from each other; and a rotary arm base for supporting the two rotary arms, the rotary arm base being movably installed in the main body.

5. The automatic vending machine for fruit juice according to claim 1, wherein the two rotary arms are placed at respective locations spaced apart from each other by a predetermined distance, a lower end of each of the rotary arms is coupled to a drive shaft of a first drive unit, thus receiving rotating force from the drive shaft, an upper end of each of the rotary arms is provided with a bowl-shaped fruit holder for seating fresh fruit therein, and the fruit holder is provided with a gripper for holding and discharging the fresh fruit.

6. The automatic vending machine for fruit juice according to claim 4, wherein the rotary arm unit comprises:
a first drive unit for rotating the two rotary arms in opposite directions; and
a second drive unit for moving the rotary arm base, to which the two rotary arms are securely mounted, upwards and downwards.

7. The automatic vending machine for fruit juice according to claim 1, wherein the fruit cutting unit comprises:
the blade for cutting the fruit, held by the two rotary arms, into two pieces; and
a blade holder for holding the blade.

8. The automatic vending machine for fruit juice according to claim 1, wherein the control unit controls a first drive unit such that first and second rotary arms are rotated inwards until the rotary arms face each other, thus holding the fruit; controls a second drive unit such that a rotary arm base, to which the first and second rotary arms are securely mounted, is moved downwards, thus cutting the fruit, held by the first and second rotary arms, into two pieces using the blade placed below the rotary arm base; controls the first drive unit such that the first and second rotary arms are rotated downwards until the rotary arms are oriented in vertical directions; and controls the second drive unit such that the rotary arm base is moved downwards, so that the two cut pieces of fruit, held in respective ends of the first and second rotary arms, are crushed by the crushing bars, vertically placed below the rotary arm base, thus making fresh fruit juice.

9. The automatic vending machine for fruit juice according to claim 1, wherein the control unit comprises a transmission terminal unit electrically connected to a remote data transmission module, thus transmitting information about a kind and amount of sold fresh fruit and an operational state of the vending machine to a terminal of a manager, located at a place distant from the vending machine, and receiving a command signal output from the terminal of the manager and controlling the vending machine in accordance with the command signal, so that the manager remotely monitors and remotely controls the operation of the vending machine.

10. A method of controlling an automatic vending machine for fruit juice, comprising:
determining a value of an input bill or coin, a kind and amount of fresh fruit selected by a consumer and a presence of a cup;
when a cup and selected fresh fruit are present in the vending machine, feeding the selected fruit, cutting the fruit into two pieces while holing the fruit, crushing the two pieces of the cut fruit into fruit juice, discharging peels of the crushed fruit and returning rotary arms to original positions thereof; and
transmitting information about the kind and amount of sold fruit juice to a terminal, located at a place distant from the vending machine, and receiving a control signal output from the terminal and controlling the vending machine according to the input control signal.

11. A method of controlling an automatic vending machine for fruit juice, the vending machine comprising first and second rotary arms rotated in opposite directions to hold fed fresh fruit, a rotary arm base supporting the first and second rotary arms thereon and movably installed in a main body of the vending machine, a blade installed between the two rotary arms, a first drive unit for rotating the first and second rotary arms in opposite directions, a second drive unit for moving the rotary arm base upwards and downwards, two crushing bars vertically oriented below the first and second rotary arms such that the crushing bars correspond to the first and second rotary arms, respectively, a filtering net placed below the crushing bars and removing a solid fraction from fruit juice, a peel discharge tray for discharging peels of crushed fruit remaining on the first and second rotary arms, and a control unit electrically connected to the first and second rotary arms and controlling the first and second rotary arms, the method comprising:
determining whether fruit is dropped into a fruit holder of the first rotary arm, and when fruit has been dropped into the fruit holder of the first rotary arm, operating a gripper of the first rotary arm to hold the fruit, and operating the first drive unit to rotate the first and second rotary arms inwards, thus holding the fruit between the first and second rotary arms;
operating the second drive unit to move the rotary arm base downwards, thus moving the first and second rotary arms holding the fruit downwards, and cutting the fruit into two pieces using the blade placed below the rotary arm base; and
controlling the first drive unit such that the facing first and second rotary arms are rotated downwards to be oriented vertically, and controlling the second drive unit such that the rotary arm base is moved downwards, and the pieces of the cut fresh fruit, held by the first and second rotary arms, are crushed between the first and second rotary arms and the crushing bars, thus making fruit juice.

12. The method of controlling an automatic vending machine for fruit juice according to claim 11, wherein the control unit transmits information about the kind and amount of sold fresh fruit and the operational state of the vending machine to a terminal of a manager, located at a place distant from the vending machine, through both a transmission terminal unit and a remote data transmission module; the manager transmits a control signal to the control unit by manipulating an input unit of the terminal; and the control unit receives the controls signal both through the remote data transmission module and through the transmission terminal unit and controls the vending machine in accordance with the control signal.

13. The method of controlling an automatic vending machine for fruit juice according to claim 11, further comprising:
operating the second drive unit to move the first and second rotary arms upwards and, at the same time, operating the first drive unit to rotate the first and second rotary arms outwards, and releasing holding force of the grippers to discharge the peels of the crushed fruit onto the peel discharge tray.

14. The method of controlling an automatic vending machine for fruit juice according to claim 11, further comprising:
determining whether or not the interior of a fruit crushing unit is clean, and when the interior of the fruit crushing unit is not clean, operating a water pump to wash the interior of the fruit crushing unit.

15. The automatic vending machine for fruit juice according to claim 1, wherein, to separately store different kinds of fresh fruit in the fruit storage unit of the main body, a partition wall is provided in the fruit storage unit, thus dividing the fruit storage unit into a first storage part and a second storage part, wherein each of the first storage part and the second storage part is provided with the fruit feeding unit for feeding stored fresh fruit, thus allowing a consumer to select a first kind of fresh fruit, a second kind of fresh fruit, or a mixture of the first and second kinds of fresh fruit.

16. The automatic vending machine for fruit juice according to claim 4, wherein the two rotary arms are placed at respective locations spaced apart from each other by a predetermined distance, a lower end of each of the rotary arms is coupled to a drive shaft of a first drive unit, thus receiving rotating force from the drive shaft, an upper end of each of the rotary arms is provided with a bowl-shaped fruit holder for seating fresh fruit therein, and the fruit holder is provided with a gripper for holding and discharging the fresh fruit.

17. The automatic vending machine for fruit juice according to claim 8, wherein the control unit comprises a transmission terminal unit electrically connected to a remote data transmission module, thus transmitting information about a kind and amount of sold fresh fruit and an operational state of the vending machine to a terminal of a manager, located at a place distant from the vending machine, and receiving a command signal output from the terminal of the manager and controlling the vending machine in accordance with the command signal, so that the manager remotely monitors and remotely controls the operation of the vending machine.
